(19) United States
(12) Patent Application Publication
(10) Pub. No.: US 2016/0165934 A1
(43) Pub. Date: Jun. 16, 2016

(54) COFFEE FRUIT PRODUCTS AND PROCESSING

(71) Applicant: Edward HIRSCHBERG, South San Francisco, CA (US)

(72) Inventor: Edward HIRSCHBERG, South San Francisco, CA (US)

(21) Appl. No.: 14/904,068

(22) PCT Filed: Jul. 21, 2014
(86) PCT No.: PCT/US14/47438

§ 371 Date: Jan. 8, 2016

Related U.S. Application Data
(60) Provisional application No. 61/857,563, filed on Jul. 23, 2013.

(51) Int. Cl. A23F 5/02; A23L 1/212

(52) U.S. Cl. CPC A23L 1/2126; A23V 2002/00

(57) ABSTRACT

The present invention provides coffee fruit products and methods for making them. The coffee fruit products can be used to prepare a variety of food products.

### CROSS-REFERENCES TO RELATED APPLICATIONS

This application claims priority to U.S. Provisional Application No. 61/857,563, filed Jul. 23, 2013, which is incorporated herein by reference.

### BACKGROUND OF THE INVENTION

A coffee bean is a seed of a coffee plant. It is contained within the red or purple fruit, which is referred to as a cherry. In most methods of processing the coffee fruit to prepare coffee beans, the fruit pulp, mucilage and hull are discarded. The present invention provides new food products made from this waste material (referred to here as coffee fruit material) and methods for processing the coffee fruit material to prepare food products.

### BRIEF SUMMARY OF THE INVENTION

The present invention provides dried coffee fruit products suitable for admixing with consumable products to prepare a wide array of coffee fruit food products. Any of a number of standard means for separating the bean from the coffee fruit material can be used. After the beans are separated from the coffee fruit material and the beans are laid out to dry, the coffee fruit material can be processed in a number of ways. For example the coffee fruit material can be dried by solar reflective drying. Another method is to cover a rack of coffee fruit material with a canopy and blow dry air (e.g., powered by a solar energy directly and/or stored in a battery to continue 24 hours a day) continuously across a desiccant, (for example, silicon dioxide). Another method is to soak the fruit pulp in an infusion media (e.g., sugar, juice concentrate, inulin, trehalose, sorbitol, and the like) until stable or/and further dehydrated. Another procedure is mash the coffee fruit material and admix with a starch or starch solution (e.g., tapioca, rice, corn and potato) and dry into sheets, strips, bars, crackers, snacks, etc. and seasoned for local application, or additives for foods. If desired, any of a number of standard methods for preserving the coffee fruit material can be used. Examples include fermenting, enzyme, acid treatment (e.g., citric acid) or salt preserving. Other methods include cryogenic methods, aseptic methods, dehydrating, freezing and freeze drying.

### DETAILED DESCRIPTION OF THE INVENTION

### Preparation of Coffee Fruit Product of the Invention

The starting material for the methods of the invention is the waste material which is typically discarded in the process of harvesting and roasting coffee beans from coffee cherries. Those parts of the coffee cherry that are typically discarded include the pulp, the mucilage, and the hull (collectively referred to here as the “coffee fruit material”). In some embodiments, coffee tree leaves are processed using the methods of the invention, either alone or admixed with the coffee fruit material. The coffee cherries are typically fully mature cherries.

The coffee fruit material after being split and separated from the two coffee beans, is preserved in a form that allows for storage and shipping the material for further processing, if desired. In the typical embodiment, the coffee fruit material is dried. For example, the material is placed on a rack which is covered with canopy and dried at ambient temperature. The drying temperature is typically less than about 110° F., usually between about 80° F. and about 100° F. A solar operated fan can be used to blow dry air over the material until the fruit is dry. In some embodiments, a desiccation material (e.g., silicon dioxide) can be used. Drying time is typically between about 18 and about 32 hours. Usually about 24 hours. Solar energy can be used to charge a battery so that the drying will continue at night for continuous dehydration, drying in approximately 24 hours. This process can be adapted for drying the green coffee beans.

After drying, the coffee fruit material can be ground or milled using standard techniques. The material is typically ground to a particle size that passes through a 20 mesh screen. In some embodiments, the particles size passes through an 80 mesh screen. In other embodiments, the material is coarsely ground. In these embodiments, the particle size ranges from about 1/16^{th} inch to about 3/16^{th}, typically an ⅛^{th} inch.

In an alternate process, the coffee fruit material is soaked in an infusion solution comprising a high concentration of sugar or sugar alcohol. A typical infusion solution is at least about 60° BRIX. Sugars and sugar alcohols well known in the art can be used for this purpose. Examples include trehalose, inulin, maltose and erythritol.

Other processes of preserving the coffee fruit material can be used. For example, the material can pickled by soaking in a brine or vinegar solution according to standard methods. In addition, the pH of the material can be changed by adding buffers, acids (e.g., citric acid), or bases to the material. In other embodiments, enzyme solutions can be added to the material (e.g., the pureed pulp). Examples include use amylase to convert starches in the pulp to sugars. In other embodiments, the coffee waste products can be mixed with a starch, ground and then dried. The starch can be derived from any source, such as cassava, rice, wheat, and the like.

In some embodiments, the material is pasteurized using standard techniques (e.g., high intensity electric field pulses). Juice can also be obtained by, for example, rupturing the cell membranes and pressure extracting. The resulting juice can be consumed, as is, concentrated, or extracted to obtain beneficial nutraceuticals or phytochemicals. In still other embodiments, the coffee food product and/or leaf is ground fresh, and then dried. The product can be ground and used loose or in tea bags with or without tea leaves.

### Coffee Fruit Food Products

A variety of coffee fruit food products can be produced from the coffee fruit products of the invention. The coffee fruit food products of the invention product include any product suitable for ingestion by a human or animal for nutritional or other purpose. Food products of the invention include solid products (e.g., dietary supplements, snack bars, bagged teas, and the like) or liquid products (e.g., beverages such as teas, syrups, and the like).

For example, homogenizing and drying the coffee fruit material (with or without standard carriers, starches and/or sugars) into fine particles can be used to produce coffee fruit products like powder, fig paste-like jam or jelly. The ground coffee fruit product powders can also be used in a beverage, either loose or in tea bags. Powders could be used as a nutritive addition to smoothies, drinks, baked goods, deserts and main dishes. The coffee fruit products of the invention can also be made into spreads, jams, chutney, and the like.

By admixing the coffee fruit products of the invention with cocoa butter and/or other fats and oils and soy lecithin, chocolate-like forms can be made as coffee bars, chunks, pieces, and various confections or coating for various bars or centers such as crunchy, chewy bars or fondant center of coffee fruit.

If the coffee fruit product is in the form of a powder, it can be mixed with water soluble food gums (e.g., agar agar, alginate, carrageenan, cassia gum, cellulose gum, locust bean gum, and the like) and coffee concentrate to form a gel, which is then formed or extruded into bars. The bars are further dried into a chewy shelf stable texture.

Further food products prepared from the coffee fruit products of the invention include chocolate-like bars, snacks, pieces, coated bon bons, truffles and boxed chocolate-like products.

Fresh or dried ground coffee fruit products can be blended with additional products made with ground coffee beans, coffee tea (especially with coffee leaves), to produce wafers, tea cakes, cookies, drinks like boba tea (that uses tapioca balls), chocolates, brownies, baking morsels, formed balls (malted milk), M&M's™, liquors, wines, nutritive packets, cereals, breads, flavored bars (e.g., hazelnut, cinnamon, vanilla, caramel, other varietal coffees, espresso), sugar crystals, weight loss foods, and meal replacements. In addition, fruit powders and/or herbs can be mixed with the coffee fruit prior to drying, to be made into a chocolate like product or used as inclusions in drinks, deserts, smoothies, sorbets, fruit soup, etc.

The incorporation of the coffee tree leaves can be included in the original drying of the coffee fruit product to increase the nutrient level of the mix. In some circumstances where the coffee fruit product is included into foods the coffee bean grounds are included such as teas and other preparations.

By incorporating gums, alginates and other binders, texturizers chunk, pieces, bars can be made with raisins, nut meats, general particulates, etc., and can be incorporated into muffins, cupcakes, breads, cookies, cereals, yogurt, ice creams, and various desserts.

Ingredients in foods containing rice or grain, various fruited tea beverages and smoothies can also be made.

Chewy Snack Bars

Dehydrated coffee fruit material is mixed with an infusion solution usually sugar at a preferred level of 60° BRIX overnight and drying it completely. Alternatively previously infused coffee fruit material is dried and then used. Grind the fruit blend into a fine powder. Blend the powder in 1:1.5 ratio (by weight) with an infusion solution of 60° BRIX with added gum or pectin as the product starts to firm. Extrude the product into bars. Dry these bars adequately to give chewy consistency. If the Aw (water activity) is too high add glycerol approximately 10% to the liquid. Additionally add approximately 2% of coffee concentrate or instant coffee to the blend.

A variation of the chewy bar form can be prepared by adding dry coarsely ground coffee fruit material that has been mixed with starch (e.g., cassava root starch) solution. This adds a crunchy texture to the bar. The texture can be further adjusted using algae powder. The product can be formed or extruded into bars and dried to a soft, crunchy texture.

Crunchy Snack Bars

When making the infused coffee fruit add either 2% concentrate of 2% instant coffee (approximate) for flavor. After redrying the mixture, chop or reduce the coffee fruit to approximately ⅛ inch particles. Add algae powder or crunchy lentil or cereal for adjusting texture.

Coating

By taking the finely ground coffee fruit and blending with approximated 25% sugar, 30% cocoa butter (or palm oil or coconut oil) and under 1% lecithin, process the blend as in making chocolate. Prepare it in a melted form and pan the bars. The preparation should be made for high melt temperatures for shipping and storage.

Other formed snack bars can be made with different coffee flavors. Instead of coffee flavors other inclusions can be similarly made. For example, various fruit or herb powders and particles can be made.

What is claimed is:

1. A method for preparing a coffee fruit product, the method comprising:
(a) drying coffee fruit material; and
(b) grinding or chopping the dried coffee fruit material to produce a coffee fruit product.

2. The method of claim 1, wherein the coffee fruit material is derived from fully mature coffee cherries.

3. The method of claim 1, wherein the step of drying the coffee fruit material is carried out at ambient temperature.

4. The method of claim 1, wherein the step of drying the coffee fruit material is carried out at a temperature between about 80° F. and about 100° F.

5. The method of claim 1, wherein the coffee fruit material is ground so it that passes through a 20 mesh screen.

6. The method of claim 1, wherein the coffee fruit material is chopped to approximately ⅛ inch particles.

7. The method of claim 1, further comprising soaking the coffee fruit material in an infusion solution.

8. The method of claim 7, wherein the step of soaking the coffee fruit material is carried out before the step of drying the coffee fruit material.

9. The method of claim 1, further comprising admixing the coffee fruit product with a consumable product to prepare a coffee fruit food product.

10. The method of claim 9, wherein the coffee fruit food product is a beverage, a dietary supplement, or a snack bar.

11. The method of claim 9, wherein the coffee fruit product is admixed with a water soluble food gum.

12. The method of claim 11, further comprising extruding the admixed material to produce a snack bar.

13. The method of claim 9, wherein the coffee fruit product is admixed with a starch solution.

14. The method of claim 9, wherein the coffee fruit product is admixed with cocoa butter.

15. The method of claim 9, wherein the coffee fruit product is admixed with tea leaves, ground coffee, and/or coffee leaves.
